(19) United States
(12) Patent Application Publication
(10) Pub. No.: US 2002/0171829 A1
(43) Pub. Date: Nov. 21, 2002

(54) Apparatus and method of measuring polarization mode dispersion, and recording medium

(75) Inventor: Tomoyu Yamashita, Saitama-ken (JP)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: ADVANTEST Corporation

(21) Appl. No.: 09/858,597

(22) Filed: May 17, 2001

(51) Int. Cl. G01J 4/00

(52) U.S. Cl. 356/369

(57) ABSTRACT

An apparatus is provided which is capable of measuring the polarization mode dispersion of an objective without changing a wavelength of an angle frequency of light incident upon the objective.

The apparatus comprises a variable wavelength light source 10 generating an incident light, a light modulator 54 modulating the incident light on the basis of the frequency f of the signal for modulation oscillated from an oscillator 52 and outputting the modulated light, a polarization controller 20 polarizing the modulated light, changing a polarizing condition so that an modulated light polarizing is passed through the axes having a minimum and a maximum propagation group velocity of the light in DUT 30, and outputting the polarized light for incidence, a phase comparator 64 measuring the phase difference φ between a phase φs of the transmitted light which the polarized light for incidence is transmitted through DUT 30 and a phase φr of the signal for modulation and a polarization mode dispersion measuring unit 66 calculating the polarization mode dispersion of DUT 30 from the phase difference φ. The apparatus is capable of measuring of the polarization mode dispersion without changing the wavelength of the incident light and if the wavelength of the incident light is changed, it is capable of measuring the wavelength dependent characteristic of the polarization mode dispersion.

### BACKGROUND OF THE INVENTION

1. Field of Invention The present invention relates to an apparatus for measuring a polarization mode dispersion of DUT (Device Under Test) such as an optical fiber.

2. Description of the Related Art

The polarization mode dispersion is a phenomenon that the propagation group velocity of a lightwave propagating an optical path such as an optical fiber and the like are varied on the basis of the polarization mode of lightwave. The polarization mode dispersion is expressed by a group delay time difference between the orthogonal polarization modes.

A Jones Matrix Method (JME Method) is one of the conventional methods for measuring the polarization mode dispersion. FIG. 5 shows a configuration of an apparatus for measuring the polarization mode dispersion by the Jones Matrix Method.

A variable wavelength light source 10 generates a variable wavelength light and the variable wavelength light is supplied to a polarization controller 20. The variable wavelength light source 10 changes a wavelength into two kinds based on the signal from a controller 50. An optical angular frequency corresponding to the two kinds of wavelengths is expressed by ω and ω+Δω, respectively.

In the polarization controller 20, the variable wavelength light becomes a linearly polarized light by a polarizer 22. A polarized light mode of the linearly polarized light is changed by a 1/2 wavelength plate 26. And, the polarized light mode of the linearly polarized light may be changed by the 1/2 wavelength plate 26, after the linearly polarized light is circularly polarized or elliptically polarized by a 1/4 wavelength plate 24. The 1/2 wavelength plate 26 changes the polarized light mode into 3 kinds (for example 0 degree, 45 degree and 90 degree) on the basis of the signal from the controller 50.

The light having the polarized light mode changed by the 1/2 wavelength plate 26 is supplied to the DUT (Device Under Test) 30 such as the optical fiber. The light that transmits the DUT 30 is inputted to a polarization analyzer 40.

From the light inputted to the polarization analyzer 40, a Jones Matrix J of the DUT 30 is obtained. Because the Jones Matrix J is a function of the optical angular frequency of the light which the variable wavelength light source 10 generates, two types of Jones Matrix J, J(ω) and J(ω+Δω) are obtained. The Jones Matrix J further has three degrees of freedom. Accordingly, after the light having three kinds of polarized light mode changed by the 1/2 wavelength plate 26 transmits the DUT 30, J(ω) and J(ω+Δω) are obtained by a transmitted light.

If Δω is very small, the characteristic values of J(ω) and J(ω+Δω) will be equal. Accordingly, by setting Δω to very small value and using the fact that the characteristic values of J(ω) and J(ω+Δω) are equal, the characteristic values are acquired from J(ω), J(ω+Δω) and Δω. A characteristic Jones Matrix is obtained from the characteristic values of Jones Matrix. The polarization mode dispersion can be known from the characteristic Jones Matrix.

### SUMMARY OF INVENTION

In accordance with the Jones Matrix Method, however, it is difficult to measure the polarization mode dispersion, because the wavelength of the light source has to be changed into two wavelengths. Further, if the difference Δω between the optical angular frequencies is too small, the precision of the characteristic value becomes bad, and if too large, the characteristic values of J(ω) and J(ω+Δω) do not become equal when changing the wavelength of the light source.

Accordingly, it is an object of the present invention to provide an apparatus for measuring the polarization mode dispersion of the objective without changing the wavelength or the angular frequency of the light incident upon the objective.

According to the present invention described in claim 1, an apparatus for measuring a polarization mode dispersion of the objective which transmits the light, includes: a light source for generating an incident light; a light modulation unit for modulating the incident light on the basis of a frequency of an inputted signal for modulating, and outputting a modulated light; a polarizing unit for polarizing the modulated light and outputting the polarized light for incidence; and a phase difference measuring unit for measuring a phase difference between a transmitted light generated by the polarized light for incidence after transmitting the objective and the signal for modulation, wherein the polarization mode dispersion of the objective being measured from the phase difference.

According to the polarization mode dispersion measuring apparatus configured as above mentioned, a light source generates an incident light, a light modulation unit modulates the incident light on the basis of a frequency of an inputted signal for modulation and outputs a modulated light, and a polarizing unit polarizes the modulated light and outputs a polarized light for incidence.

A phase of the transmitted light in which the polarized light for incidence transmits the objective is influenced by the polarization mode dispersion. Accordingly, a difference between a phase of the transmitted light and a phase of the signal for modulation is generated as much as affected by the polarization mode dispersion.

Accordingly, the polarization mode dispersion of the objective can be measured by measuring the phase difference between the transmitted light and the signal for modulation using a phase difference measuring unit. Furthermore, it is not necessary to changes the wavelength of the incident light in order to measure the polarization mode dispersion of the objective.

The present invention described in claim 2, is an apparatus for measuring a polarization mode dispersion according to claim 1, wherein the polarizing unit polarizes the modulated light, changes a polarizing condition so that the modulated light which polarized is passed through the axes having a minimum and a maximum propagation group velocity of the light in the objective, and outputs the polarized light for incidence.

The present invention described in claim 3, is an apparatus for measuring a polarization mode dispersion according to claim 2, wherein the polarization unit makes the polarized light for incidence to be a random polarized light.

The present invention described in claim 4, is an apparatus for measuring a polarization mode dispersion according to claim 2, wherein the polarizing unit includes; a polarizer for linearly-polarizing the modulated light, a 1/4 wavelength plate for circularly-polarizing or elliptically-polarizing the linearly-polarized light outputted from the polarizer, and a 1/2 wavelength plate for changing a vibration direction of the polarized light outputted from the 1/4 wavelength plate.

According to the present invention described in claim 5, an apparatus for measuring a polarization mode dispersion according to claim 2, further includes a polarization mode dispersion calculating unit for measuring the polarization mode dispersion of the objective by the difference between the maximum value and minimum value of the phase difference and the frequency.

The present invention described in claim 6, is an apparatus for measuring a polarization mode dispersion according to claim 2, wherein the light source changes a wavelength of the incident light and measures the polarization mode dispersions of the objective is measured corresponding to the wavelength of the incident light.

In order to measure the polarization mode dispersion of the objective, it is not necessary to changes the wavelength of the incident light. However, if desired, by changing the wavelength of the incident light, a wavelength dependent characteristic in the polarization mode dispersion of the objective can be measured.

According to the present invention described in claim 7, a method for measuring a polarization mode dispersion of the objective which transmits the light, includes: a light generating step for generating an incident light; a light modulation step for modulating the incident light on the basis of a frequency of an inputted signal for modulating, and outputting a modulated light; a polarizing step for polarizing the modulated light and outputting the polarized light for incidence; and a phase difference measuring step for measuring a phase difference between a transmitted light generated by the polarized light for incidence after transmitting the objective and the signal for modulation, wherein the polarization mode dispersion of the objective being measured from the phase difference.

The present invention described in claim 8, is a computer-readable medium having a program of instructions for execution by the computer to -perform a measuring processing for measuring a polarization mode dispersion of the objective which transmits the light, the measuring processing including: a light generating processing for generating an incident light; a light modulation processing for modulating the incident light on the basis of a frequency of an inputted signal for modulating, and outputting a modulated light; a polarizing processing for polarizing the modulated light and outputting the polarized light for incidence; and a phase difference measuring processing for measuring a phase difference between a transmitted light generated by the polarized light for incidence after transmitting the objective and the signal for modulation, wherein the polarization mode dispersion of the objective being measured from the phase difference.

According to the present invention described in claim 9, an apparatus for outputting a light, includes: a light source for generating an incident light; a light modulation unit for modulating the incident light on the basis of a frequency of an inputted signal for modulating, and outputting a modulated light; and a polarizing unit for polarizing the modulated light and outputting the polarized light for incidence.

The present invention described in claim 10, is an apparatus for outputting a light according to claim 9, wherein the polarizing unit polarizes the modulated light, changes a polarizing condition so that the modulated light which polarized is passed through the axes having a minimum and a maximum propagation group velocity of the light in the objective, and outputs the polarized light for incidence.

The present invention described in claim 11, is an apparatus for outputting a light according to claim 10, wherein the polarization unit makes the polarized light for incidence to be a random polarized light.

The present invention described in claim 12, is an apparatus for outputting a light according to claim 10, wherein the polarizing unit includes; a polarizer for linearly-polarizing the modulated light, a 1/4 wavelength plate for circularly-polarizing or elliptically-polarizing the linearly-polarized light outputted from the polarizer, and a 1/2 wavelength plate for changing a vibration direction of the polarized light outputted from the 1/4 wavelength plate.

The present invention described in claim 13, is an apparatus for outputting a light according to claim 10, wherein the light source changes a wavelength of the incident light and wherein the polarization mode dispersions of the objective is measured corresponding to the wavelength of the incident light.

### BRIEF DESCRIPTION OF THE DRAWINGS

FIG. 1 is a block diagram showing the configuration of a polarization mode dispersion measuring apparatus according to an embodiment of the invention,

FIG. 2 shows an operation of a polarization controller 20,

FIG. 3 shows a recording mode of the polarization mode dispersion,

FIG. 4 is a flow chart showing an operation according to an embodiment of the invention, and

FIG. 5 shows a conventional polarization mode dispersion measuring apparatus according to Jones Matrix Method.

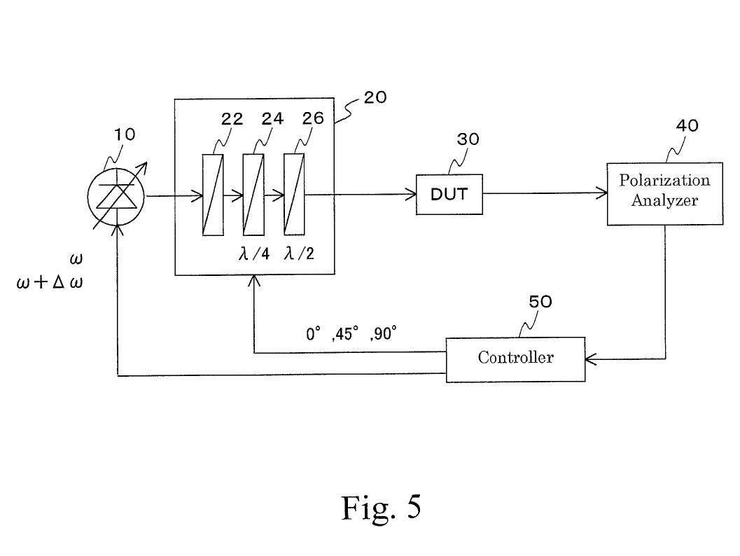

### DESCRIPTION OF THE PREFERRED EMBODIMENT

Hereinafter, the preferred embodiments of the present invention will be described referring to the attached drawings.

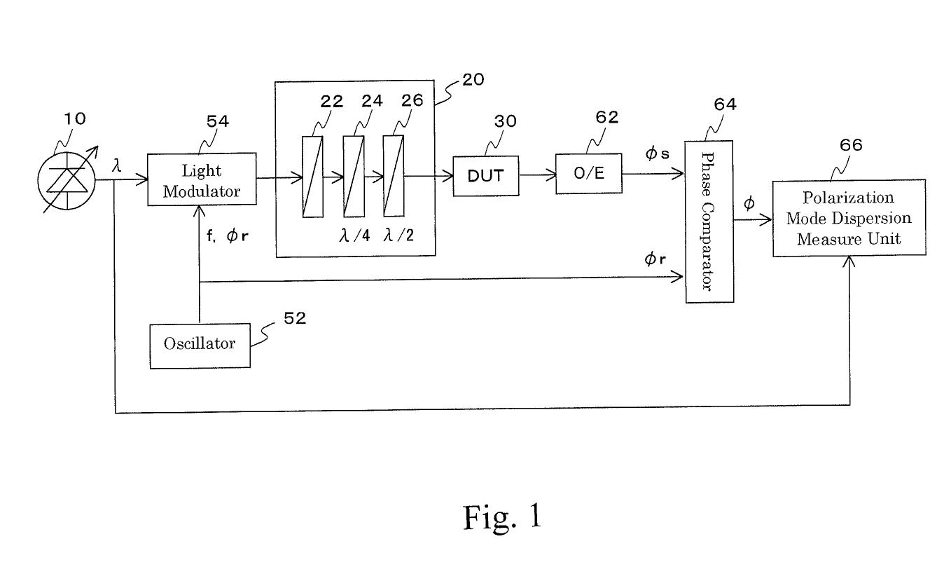

FIG. 1 is a block diagram showing the configuration of a polarization mode dispersion measuring apparatus according to an embodiment of the invention. The polarization mode dispersion measuring apparatus according to an embodiment of the invention measures the polarization mode dispersion of the DUT (objective; Device Under Test) 30 such as an optical fiber. The polarization mode dispersion measuring apparatus according to an embodiment of the invention is provided with a variable wavelength light source 10, a polarization controller 20, an oscillator 52, a light modulator 54, a photoelectric converter 62, a phase comparator 64 and a polarization mode dispersion measuring unit 66.

The variable wavelength light source 10 generates an incident light. A wavelength λ of the incident light can be swept by the variable wavelength light source 10.

The oscillator 52 generates an electric signal for modulation having a predetermined frequency f and supplies it to the light modulator 54. A phase of the electric signal for modulation is expressed by φr.

The light modulator 54 modulates the variable wavelength light to the frequency f. The light modulator 54 has a Lithium-Naiobate (LN). The incident light is modulated to a modulated light by the light modulator 54. And, the light modulator does not need to have LN, if it is able to modulate a variable wavelength light. For example, it can be an EA (Electro Absorption) modulator.

The modulated light outputted from the light modulator 54 is supplied to the polarization controller 20. The polarization controller 20 functions as a polarizing means which the modulated light is polarized. The polarization controller 20 changes the polarizing condition of the modulated light. And the polarizing condition stands for a kind of the polarized light (linearly-polarized light, elliptically-polarized light, etc), a direction of the polarized light, etc.

The polarization controller 20 has a polarizer 22, a 1/4 wavelength plate 24, a 1/2 wavelength plate 26. The polarizer 22 linearly-polarizes the modulated light. The 1/4 wavelength plate circularly or elliptically polarizes the linearly polarized light outputted from the polarizer 22.

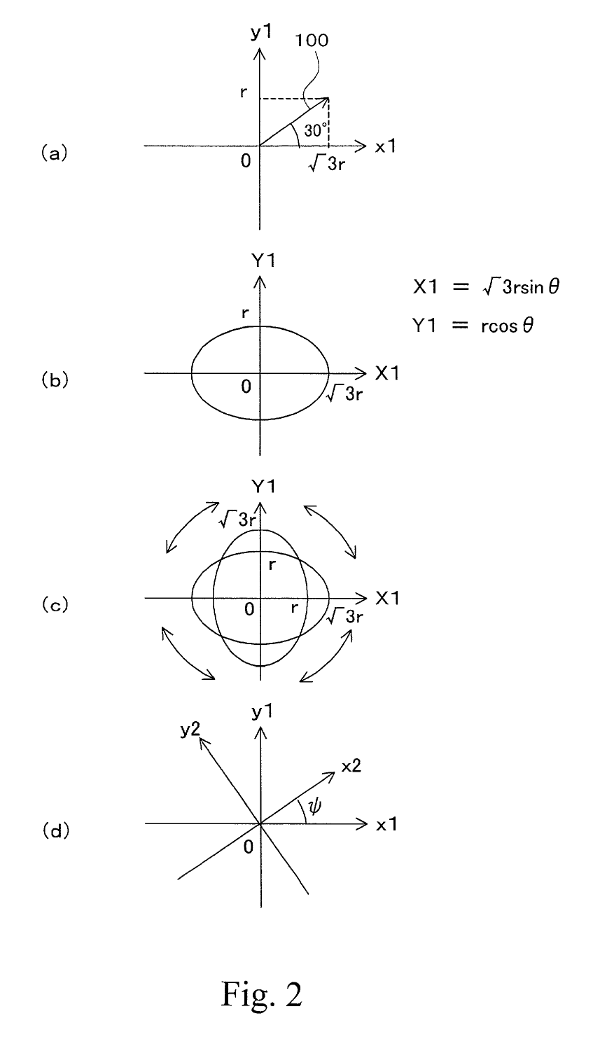

For example, as shown in FIG. 2(a), it is assumed that the linearly polarized light 100 outputted from the polarizer 22 inclines from a main axis x1 of the 1/4 wavelength plate 24 by 30 degrees. Then, a x1 component of the linearly polarized light 100 becomes √3rsinθ (r is an predetermined integer, θ is a function of time) and a y1 component becomes rsinθ (r is an predetermined integer, θ is a function of time). Furthermore, the phases of x1 component and y1 component of the linearly polarized light 100 are equal.

Herein, x1 component (refers to X1) of a ray generated by the x1 component of the linearly polarized light 100 after transmitting the 1/4 wavelength plate 24 becomes √3rsinθ (r is an predetermined integer, θ is a function of time) and the y1 component (refers to Y1) becomes rcosθ (r is an predetermined integer, θ is a function of time). According to a characteristic of the 1/4 wavelength plate 24, the phases of X1 and Y1 are displaced by π/2 each other, therefore, if the phase of X1 is sinθ, the phase of Y1 becomes cosθ. Accordingly, as shown in FIG. 2(b), the linearly polarized light becomes an elliptically polarized light by passing through the 1/4 wavelength plate 24. Furthermore, if the linearly polarized light 100 outputted from the polarizer 22 inclines from the main axis x1 of the 1/4 wavelength plate 24 by 45 degrees, it becomes a circularly polarized light.

The 1/2 wavelength plate 26 functions as a rotary polarizer because it modulates the linearly polarized light having an azimuth (angle) of β into the linearly polarized light having an azimuth (angle) of −β with respect to the main axis of the 1/2 wavelength plate 26. Accordingly, as shown in FIG. 2(c), by rotating the 1/2 wavelength plate 26, an output of 1/4 wavelength plate 24 is rotated.

In the DUT 30, an axis that the propagation group velocity of the light is a minimum is x2, an axis that the propagation group velocity of the light is a maximum is y2. Hereinafter, the axes x2, y2 may be referred as the main axes of DUT 30. As shown in FIG. 2(d), x2 and y2 are at right angles each other and are displaced from the main axes x1, y1 of the 1/4 wavelength plate 24 by the predetermined angle Ψ. Accordingly, by half-rotating the 1/2 wavelength plate 26, an oblique of a major (minor) axis of the circularly polarized light can be varied from 0 degree to 360 degree. Accordingly, the major axis or the minor axis of the circularly polarized light passes through the main axes x2, y2 of DUT 30. Also, if the oblique of the main (minor) axis of the circularly polarized light is varied from 0 degree to 360 degree, the polarized lights are generated in all polarizing planes, this is called a random polarized light in this specification. However, without limit to the random polarized lights, it is enough if the polarized light is generated so that the main axes x2, y2 of DUT 30 are passed. Furthermore, the light passing through the 1/2 wavelength plate 26 is the polarized light for incidence outputted from the polarization controller 20.

The polarized light for incidence is supplied to the DUT 30. The polarized light for incidence transmits the DUT 30. The light transmitting through the DUT 30 is called a transmitted light.

The photoelectric converter 62 photoelectric converts the transmitted light and outputs it. In the case of photoelectric converting the transmitted light, for example, the photoelectric converter 62 takes out a part of major axis of the elliptically polarized light and photoelectric converts it.

The phase comparator 64 measures a phase difference φ between the phase φs of an photoelectric converted signal of the transmitted light and the phase φr of an electric signal for modulation. Namely, φ=φs−φr.

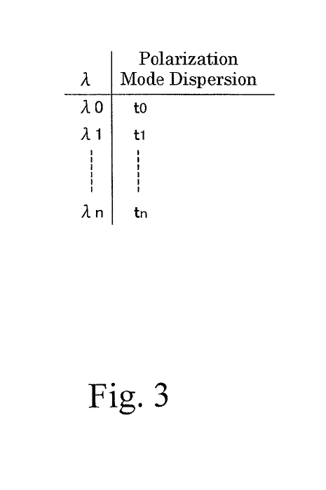

The polarization mode dispersion measuring unit 66 calculates a maximum value (φmax ) of φ and a minimum value (φmin) of φ from the output of the phase comparator 64. The φmax and φmin correspond to the main axes x2, y2 of DUT 30, respectively. The group delay time difference of the light between the main axes x2, y2 of DUT 30 becomes to the polarization mode dispersion. Accordingly, the polarization mode dispersion measuring unit 66 calculates the polarization mode dispersion from φmax, φmin and frequency f of the electric signal for modulation. For example, the polarization mode dispersion is defined as a value which the difference between the maximum value of φ and the minimum value of φ is divided by 2πf, namely, (φmax−φmin)/2πf. And the polarization mode dispersion measuring unit 66 records the polarization mode dispersion corresponding to a wavelength λ of the variable wavelength light source 10, as shown in FIG. 3. That is, it records the polarization mode dispersion t0 at wavelength λ0, the polarization mode dispersion t1 at wavelength λ1, . . . ,the polarization mode dispersion tn at wavelength λn.

In the embodiment of the invention, even though the wavelength of the incident light, which the variable wavelength light source 10 generates, is fixed, the polarization mode dispersion can be obtained. However, by recording the polarization mode dispersion as the polarization mode dispersion t0 at the wavelength λ0, the polarization mode dispersion t1 at the wavelength λ1, . . . , the polarization mode dispersion tn at the wavelength λn, the wavelength dependent characteristic of the polarization mode dispersion can be measured.

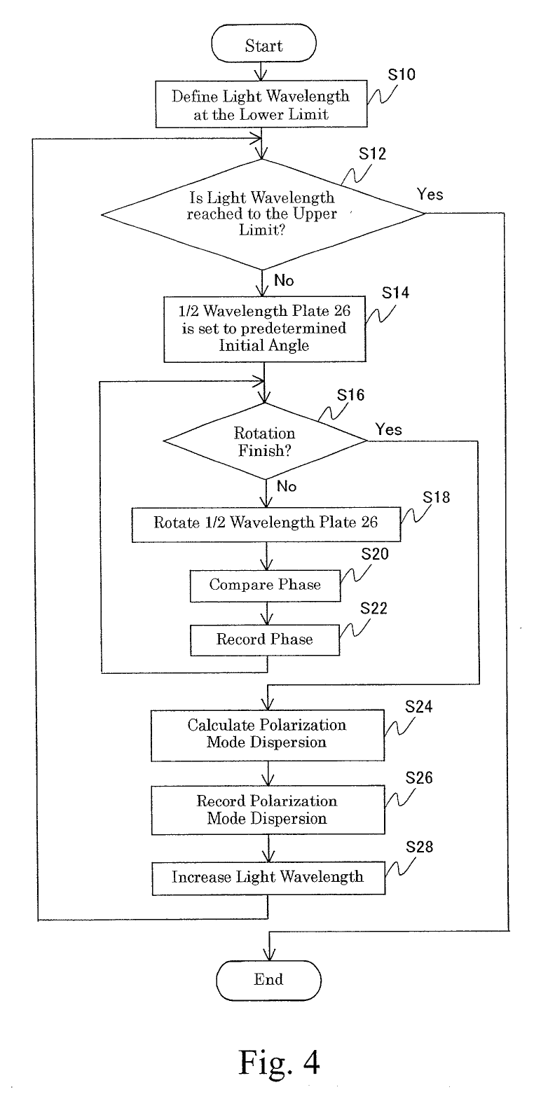

Next, the operation according to an embodiment of the invention will be described using a flow chart of FIG. 4. First, the wavelength λ of the incident light generated from the variable wavelength light source 10 is defined as the lower limit (S10). And, if the wavelength λ of the incident light is not reached to the upper limit (S12, No), the 1/2 wavelength plate 26 is located at the predetermined initial angle (S14). And, if the rotation of 1/2 wavelength plate 26 is not finished (S16, No), the 1/2 wavelength plate 26 is rotated (S18). At this time, the polarizer 22 and 1/4 wavelength plate 24 are fixed at the predetermined angle. And, it measures the phase difference φ between the phase φs of transmitted light after photoelectric converting and the phase φr of the electric signal for modulation (S20) and records the phase difference φ in the polarization mode dispersion measuring unit 66 (S22).

Herein, if the rotation of the 1/2 wavelength plate 26 is finished (S16, Yes), the polarization mode dispersion measuring unit 66 measures the polarization mode dispersion from the maximum value φmax and the minimum value φmin of the phase difference φ and the frequency f of the electric signal for modulation (S24). And, the polarization mode dispersion measuring unit 66 records the polarization mode dispersion tn corresponding to the wavelength λn of the incident light generated from the variable wavelength light source 10 (S26).

Herein, even though the wavelength λn of the incident light generated from the variable wavelength light source 10 is fixed, the polarization mode dispersion tn can be measured. However, in order to measure the wavelength dependent characteristic of the polarization mode dispersion, the variable wavelength light source 10 increase the wavelength λn of the incident light (S28), and then it return to determination (S12) as to whether the wavelength (λ) of the incident light is reached to the highest limit. If the wavelength λ of the incident light is reached to the highest limit (S12, Yes), the operation is finished.

According to the embodiment of the invention, the phase of the transmitted light in which the polarized light for incidence transmits the DUT 30 is effected by the polarization mode dispersion. Accordingly, the phase φs of the transmitted light generates the phase φr of the signal for modulation and the phase difference φ as much as it is affected by the polarization mode dispersion.

Also, the polarized light for incidence is made to pass through the axis x2 where the propagation group velocity of the light is minimum and the axis y2 where the propagation group velocity of the light is maximum in the DUT 30.

Accordingly, the phase comparator 64 measures the phase difference φ between the phase φs of the transmitted light and the phase φr of the signal for modulation. The polarization mode dispersion measure unit 66 calculates the group delay time difference of the light in the axis x2 having the minimum propagation group velocity and the axis y2 having the maximum propagation group velocity of the light. Thereby, the polarization mode dispersion of DUT 30 can be measured without changing the wavelength of the incident light.

Furthermore, if the wavelength of the incident light is varied, the wavelength dependent characteristic of the polarization mode dispersion can be measured.

And, because the phase difference φ is a function of the polarization mode dispersion, even though the polarized light for incidence is not passed through the main axes x2, y2, it is theoretically possible to calculate the polarization mode dispersion from the phase difference φ.

Also, the above embodiment according to the invention is executed as follow. In a media reading device of computer comprising a CPU, a hard disk, media (flopy disk, CD-ROM, etc) reading device, it is read the media recording a program embodying each component of the above-mentioned, and is installed to the hard disk. By the above method, the above function can be executed.

[Effect of the Invention]

According to the invention, the phase of the transmitted light in which the polarized light for incidence is transmitted through the objective is effected by the polarization mode dispersion. Accordingly, the difference between the phase of the transmitted light and the phase of the signal for modulation is generated as much as it is affected by the polarization mode dispersion.

Accordingly, the phase difference measuring means measures the phase difference between the phase of the transmitted light and the phase of the signal for modulation, thereby it is possible to measure the polarization mode dispersion of the objective.

What is claimed is:

1. An apparatus for measuring a polarization mode dispersion of the objective which transmits the light, comprising:
a light source for generating an incident light;
a light modulation means for modulating said incident light on the basis of a frequency of an inputted signal for modulating, and outputting a modulated light;
a polarizing means for polarizing said modulated light and outputting the polarized light for incidence; and
a phase difference measuring means for measuring a phase difference between a transmitted light generated by the polarized light for incidence after transmitting said objective and said signal for modulation,
wherein the polarization mode dispersion of said objective being measured from said phase difference.

2. An apparatus for measuring a polarization mode dispersion according to claim 1, wherein said polarizing means polarizes said modulated light, changes a polarizing condition so that said modulated light which polarized is passed through the axes having a minimum and a maximum propagation group velocity of the light in said objective, and outputs the polarized light for incidence.

3. An apparatus for measuring a polarization mode dispersion according to claim 2, wherein said polarization means makes the polarized light for incidence to be a random polarized light.

4. An apparatus for measuring a polarization mode dispersion according to claim 2, wherein said polarizing means comprises;
a polarizer for linearly-polarizing said modulated light,
a 1/4 wavelength plate for circularly-polarizing or elliptically-polarizing the linearly-polarized light outputted from said polarizer, and
a 1/2 wavelength plate for changing a vibration direction of the polarized light outputted from said 1/4 wavelength plate.

5. An apparatus for measuring a polarization mode dispersion according to claim 2, further comprises a polarization mode dispersion calculating means for measuring the polarization mode dispersion of said objective by the difference between the maximum value and minimum value of said phase difference and said frequency.

6. An apparatus for measuring a polarization mode dispersion according to claim 2, wherein said light source changes a wavelength of said incident light and wherein the polarization mode dispersions of said objective is measured corresponding to said wavelength of said incident light.

7. A method for measuring a polarization mode dispersion of the objective which transmits the light, comprising:
a light generating step for generating an incident light;
a light modulation step for modulating said incident light on the basis of a frequency of an inputted signal for modulating, and outputting a modulated light;
a polarizing step for polarizing said modulated light and outputting the polarized light for incidence; and
a phase difference measuring step for measuring a phase difference between a transmitted light generated by the polarized light for incidence after transmitting said objective and said signal for modulation,
wherein the polarization mode dispersion of said objective being measured from said phase difference.

8. A computer-readable medium having a program of instructions for execution by the computer to perform a measuring processing for measuring a polarization mode dispersion of the objective which transmits the light, said measuring processing comprising:
a light generating processing for generating an incident light;
a light modulation processing for modulating said incident light on the basis of a frequency of an inputted signal for modulating, and outputting a modulated light;
a polarizing processing for polarizing said modulated light and outputting the polarized light for incidence; and
a phase difference measuring processing for measuring a phase difference between a transmitted light generated by the polarized light for incidence after transmitting said objective and said signal for modulation,
wherein the polarization mode dispersion of said objective being measured from said phase difference.

9. An apparatus for outputting a light, comprising:
a light source for generating an incident light;
a light modulation means for modulating said incident light on the basis of a frequency of an inputted signal for modulating, and outputting a modulated light; and
a polarizing means for polarizing said modulated light and outputting the polarized light for incidence.

10. An apparatus for outputting a light according to claim 9, wherein said polarizing means polarizes said modulated light, changes a polarizing condition so that said modulated light which polarized is passed through the axes having a minimum and a maximum propagation group velocity of the light in said objective, and outputs the polarized light for incidence.

11. An apparatus for outputting a light according to claim 10, wherein said polarization means makes the polarized light for incidence to be a random polarized light.

12. An apparatus for outputting a light according to claim 10, wherein said polarizing means comprises;
a polarizer for linearly-polarizing said modulated light,
a 1/4 wavelength plate for circularly-polarizing or elliptically-polarizing the linearly-polarized light outputted from said polarizer, and
a 1/2 wavelength plate for changing a vibration direction of the polarized light outputted from said 1/4 wavelength plate.

13. An apparatus for outputting a light according to claim 10, wherein said light source changes a wavelength of said incident light and wherein the polarization mode dispersions of said objective is measured corresponding to said wavelength of said incident light.
